(19) United States
(12) Patent Application Publication
(10) Pub. No.: US 2006/0146530 A1
(43) Pub. Date: Jul. 6, 2006

(54) Led backlight apparatus

(75) Inventors: Jung Kyu Park, Seoul (KR); Hun Joo Hahm, Kyungki-do (KR); Ho Sik Ahn, Kyungki-do (KR); Bum Jin Kim, Kyungki-do (KR); Young Sam Park, Seoul (KR); Hyung Suk Kim, Kyungki-do (KR); Young June Jeong, Kyungki-do (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Kyungki-do (KR)

(21) Appl. No.: 11/134,430

(22) Filed: May 23, 2005

(30) Foreign Application Priority Data
Dec. 30, 2004 (KR) 10-2004-116279

(51) Int. Cl. F21V 7/00

(52) U.S. Cl. 362/240; 362/241; 362/247

(57) ABSTRACT

This invention relates to an LED backlight apparatus. The LED backlight apparatus comprises: a housing having an upper opening; a reflective sheet provided on a bottom inside the housing; a plurality of LED light sources arranged above the reflective sheet at a predetermined distance to emit light toward the reflective sheet; and a light source support connected to a side wall of the housing to support the LED light sources. The light sources are arranged opposite to the reflective sheet so that light beams emitted from the LED light sources reflect from the reflective sheet before entering a diffuser plate behind the LED light sources from the reflective sheet, thereby potentially reducing the thickness of the backlight apparatus while ensuring a distance for the light beams to sufficiently mix together before entering the differ plate.

### CLAIM OF PRIORITY

This application claims the benefit of Korean Patent Application No. 10-2004-0116279 filed on Dec. 30, 2004, in the Korean Intellectual Property Office, the disclosure of which is incorporated herein by reference.

### BACKGROUND OF THE INVENTION

1. Field of the Invention

The present invention relates to a backlight apparatus having Light Emitting Diodes (LEDs), and more particularly, in which LED light sources are arranged opposite to a reflective sheet so that light beams emitted from the LED light sources reflect from a reflective sheet before entering a diffuser plate behind the LED light sources, thereby potentially reducing the thickness of the backlight apparatus while ensuring a distance for the light beams to sufficiently mix together before entering the differ plate.

2. Description of the Related Art

LCD backlight apparatuses using Light Emitting Diodes (LEDs) illuminate an LCD panel via direct illumination or side-emitting illumination. In the side-emitting illumination, light from a light source is emitted in lateral directions and then re-directed upward via a reflective plate or a scattering pattern to illuminate the LCD panel. On the contrary, in the direct illumination, light sources are installed under the LCD panel so that light emitted laterally from the light sources are projected upward onto the LCD panel.

FIG. 1 is a schematic cross-sectional view of a conventional side backlight apparatus. As shown in FIG. 1, the side backlight apparatus includes a sheet-shaped reflective plate 12, a light guide plate 16 placed on the reflective plate 12 and having a scattering pattern 14 formed on the underside thereof, and bar type LED light sources 18 and 20 placed at both sides of the light guide plate 16.

The LED light sources 18 and 20 emit light L laterally into the light guide plate 16 so that light L propagates through the light guide plate 16, and upon colliding against the scattering pattern 14, is scattered upward, thereby to backlight an LCD panel 22 above the light guide plate 16.

The side backlight apparatus 10 as above advantageously has a thin and simple structure. Another advantage of this backlight apparatus is that the intensity of light directed upward can be uniformly adjusted through the design of the scattering pattern 14 formed in the top face of the reflective plate 12 or the underside of the light guide plate 16. However, this structure is not applicable to a large-sized LCD since light from the LED light sources 18 and 20 can be sent to a limited distance only.

FIG. 2 is a schematic cross-sectional view of a conventional direct backlight apparatus. The direct backlight apparatus 30 includes a sheet-shaped reflective plate 32, a plurality of bar-shaped LED light sources 34 placed on the reflective plate 32, flat light shades 36 placed on the LED light sources 34, respectively, a transparent plate 38 placed above the light shades 36 at a predetermined gap G1 and a diffuser plate 40 placed above the transparent plate 38 at a predetermined gap G2.

The LED light sources 34 emit light beams L1 and L2 substantially in horizontal directions, and an emitted light beam L1 is reflected from the reflective plate 32 and passes through the transparent plate 38. Then, the light beam L1 is diffused by the diffuser plate 40 to a desired uniformity to backlight an LCD panel 44 placed above the diffuser plate 40. Another light beam L2 collides into the underside of the transparent plate 38 so that a partial light beam L21 is introduced into the transparent plate 38, thereby to backlight the LCD panel 42 via the diffuser 40 above the transparent plate 38. In the meantime, another partial light beam L22 of the light beam L2 is reflected from the transparent plate 38 toward the reflective sheet 32, and then from the reflective sheet 32. Then, the partial light beam L22 passes through the transparent plate 38 and the diffuser plate 40 to backlight the LCD panel 42.

The backlight apparatus 30 of this structure has an advantage in that it can effectively backlight a large-sized LCD since the plurality of bar-shaped LED light sources 34 are placed under the LCD panel 42.

However, the backlight apparatus 30 of this structure disadvantageously increases thickness since a gap G1 is required between the LED light sources 34 and the transparent plate 38 and a gap G2 is also required between the transparent plate 38 and the diffuser plate 40.

Describing it in more detail, when generated from the LED light sources 34, light L is reflected upward generally through areas between the light shades 36, forming dark areas DA and resultant bright lines. In order to remove the dark areas and the bright lines, the gap G2 is required to have at least a predetermined dimension to ensure a sufficient distance between the transparent plate 38 and the diffuser plate 40 so that light beams emitted upward from the transparent plate 38 can mix together before entering the diffuser plate 40.

As described above, since the gaps G1 and G2 are necessarily maintained at predetermined dimensions or more in order to impart uniformity to light directed from the reflective plate 32 toward the LCD panel 42, the direct backlight apparatus 30 essentially suffers from increased thickness.

### SUMMARY OF THE INVENTION

The present invention has been made to solve the foregoing problems of the prior art and it is therefore an object of the present invention to provide an LED backlight apparatus having LED light sources arranged opposite to a reflective sheet so that light beams emitted from the LED light sources are reflected from the reflective sheet and then introduced into a diffuser plate placed behind the LED light sources, thereby to reduce the thickness of the backlight apparatus while ensuring a space sufficient for the light beams to mix together before entering the diffuser plate.

It is another object of the invention to provide an LED backlight apparatus having a projection formed on a reflective sheet opposed to LED light sources to mixing light beams emitted from the LED light sources more uniformly while preventing any loss of the light beams.

It is further another object of the invention to provide an LED backlight apparatus having intermediate projections formed on a reflective sheet corresponding to areas each intermediating between adjacent LED light sources so that light beams emitted from the LED light sources are reflected upward mostly from areas between adjacent intermediate projections, thereby to prevent wide spreading of light and thus to enhance brightness.

It is yet another object of the invention to provide an LED backlight apparatus having intermediate projections extended up to a height adjacent to a diffuser plate so that light beams emitted from a group of LEDs between adjacent intermediate projections are introduced into a corresponding area of the diffuser plate, thereby to further enhance brightness.

According to an aspect of the invention for realizing the object, there is provided an LED backlight apparatus comprising: a housing having an upper opening; a reflective sheet provided on a bottom inside the housing; a plurality of LED light sources arranged above the reflective sheet at a predetermined distance to emit light toward the reflective sheet; and a light source support connected to a side wall of the housing to support the LED light sources.

The LED backlight apparatus of the invention may further comprise a projection extended upward from the reflective sheet at positions corresponding to the LED light sources, and a second projection alternating with the projection.

In this LED backlight apparatus, the projection and the second projection preferably have a triangular vertical cross section or a semicircular cross section that is convex-upward. In this case, the second projection is preferably extended to the same level as that of the LED light sources.

Furthermore, the LED backlight apparatus of the invention may further comprise a diffuser plate placed over the opening of the housing.

According to another aspect of the invention for realizing the object, there is provided an LED backlight apparatus comprising: a housing having an upper opening; a reflective sheet provided on a bottom inside the housing; a plurality of LED light sources arranged above the reflective sheet at a predetermined distance to emit light toward the reflective sheet; a plurality of first projections extended upward from the reflective sheet at positions corresponding to the LED light sources, respectively; a plurality of second projections extended upward from the reflective sheet, alternating with the first projections; and a light source support connected to a side wall of the housing to support the LED light sources.

In this LED backlight apparatus, the first and second projections may have a triangular vertical cross section or a semicircular cross section that is convex-upward.

Preferably, the second projections are extended to the same level as that of the LED light sources.

Furthermore, the LED backlight apparatus of the invention may further comprise a diffuser plate placed over the opening of the housing.

Any of the afore-described backlight apparatuses may further comprise a diffuser plate placed over the opening of the housing.

Also, any of the afore-described backlight apparatuses may further comprise a transparent plate placed between the housing and the diffuser plate.

In this LED backlight apparatus, the support may comprise a bar-shaped metal PCB with the LED light sources attached to a bottom thereof.

Any of the afore-described backlight apparatuses may further comprise a heat radiator provided on an outer surface of the hosing, the heat radiator being connected to the metal PCB.

In this LED backlight apparatus, the reflective sheet may comprise a Lambertian surface.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view of a conventional side-emitting backlight apparatus;

FIG. 2 is a schematic cross-sectional view of a conventional direct-illumination backlight apparatus;

FIG. 3 is a front cross-sectional view of an LED backlight apparatus according to a first embodiment of the invention;

FIG. 4 is a side cross-sectional view taken along the line 4-4 of FIG. 3;

FIG. 5 is an exploded perspective view of the backlight apparatus shown in FIG. 3;

FIG. 6 is a front cross-sectional view illustrating the operation of the backlight apparatus shown in FIG. 3;

FIG. 7 is a cross-sectional view illustrating the backlight apparatus shown in FIG. 4, equipped with a heat sink;

FIG. 8 is a front cross-sectional view of an alternative to the backlight apparatus shown in FIG. 3;

FIG. 9 is a front cross-sectional view of an LED backlight apparatus according to a second embodiment of the invention;

FIGS. 10 to 12 are perspective views illustrating projections adopted to the backlight apparatus shown in FIG. 9;

FIG. 13 is a front cross-sectional view of an LED backlight apparatus according to a third embodiment of the invention;

FIG. 14 is a front cross-sectional view of an LED backlight apparatus according to a fourth embodiment of the invention; and

FIG. 15 is a plan view of a diffuser plate in use with the backlight apparatus shown in FIG. 14.

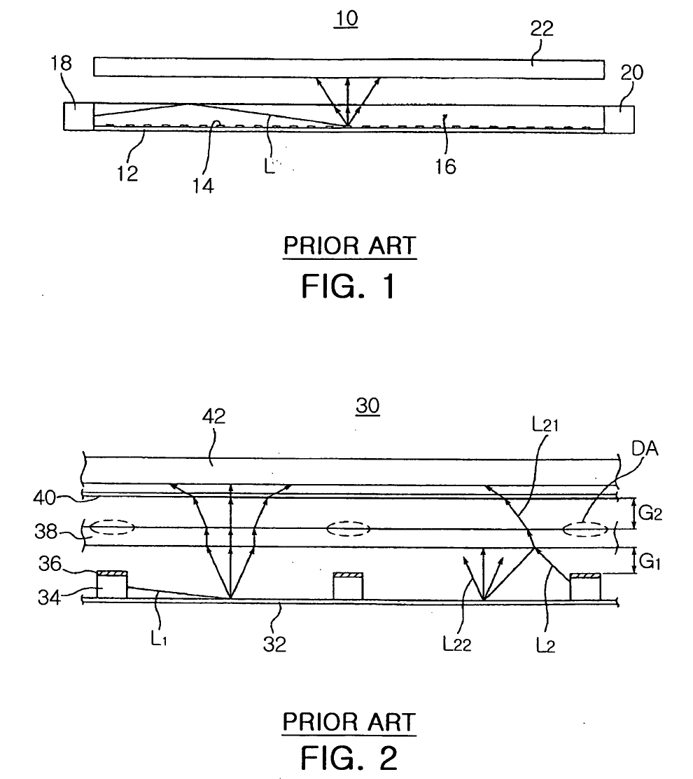

### DETAILED DESCRIPTION OF THE PREFERRED EMBODIMENT

A preferred embodiment of the present invention will now be described in detail with reference to the accompanying drawings.

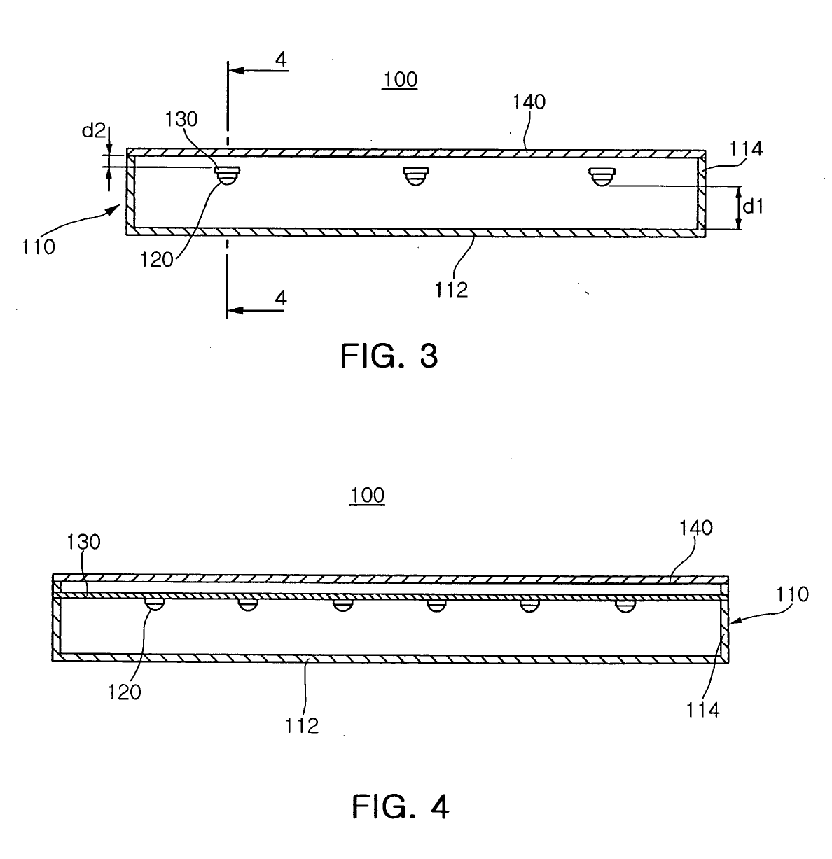

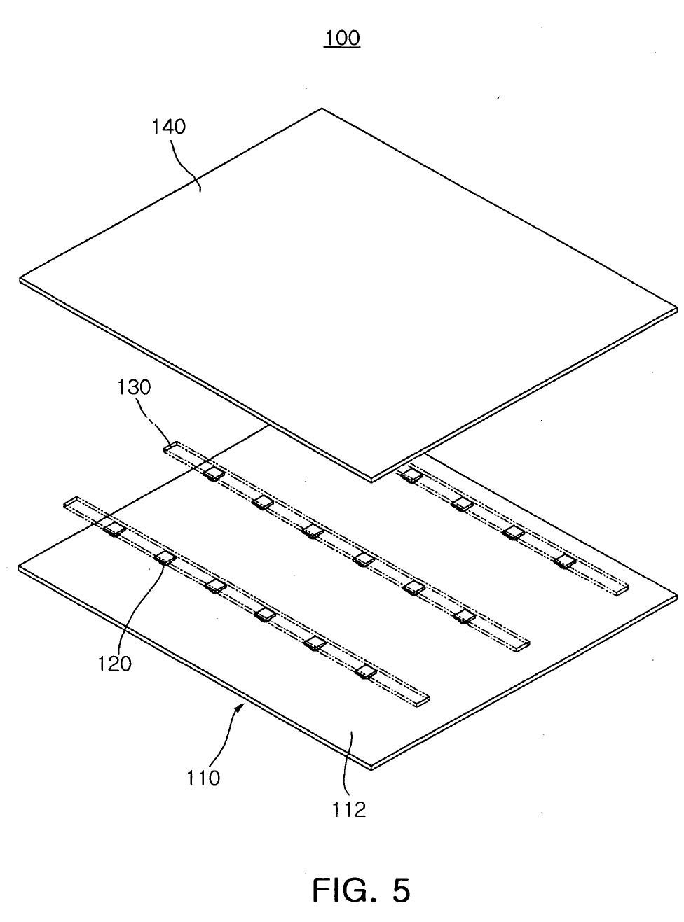

FIG. 3 is a front cross-sectional view of an LED backlight apparatus 100 according to a first embodiment of the invention, FIG. 4 is a side cross-sectional view taken along the line 4-4 of FIG. 3, and FIG. 5 is an exploded perspective view of the backlight apparatus shown in FIG. 3.

Referring to FIGS. 3 to 5, the backlight apparatus according to the first embodiment of the invention includes a housing 110 having an upper opening, a plurality of LEDs 120 placed within the housing 110 adjacent to the opening and bar-shaped PCBs 130 connected to side walls 114 of the housing 110 and functioning as a bracket to support the LEDs 120. Besides, a diffuser plate 140 is placed over the opening of the housing 110.

The housing 110 is hollow to receive the LEDs 120 and the PCBs 130, and has a reflective sheet 112 placed in the bottom. The side walls 114 are preferably made of a reflective sheet. The reflective sheet 112 may be preferably made of a Lambertian sheet or have a Lambertian surface formed in its upper surface. Alternatively, a reflective pattern such as ink dot pattern may be selectively or partially provided.

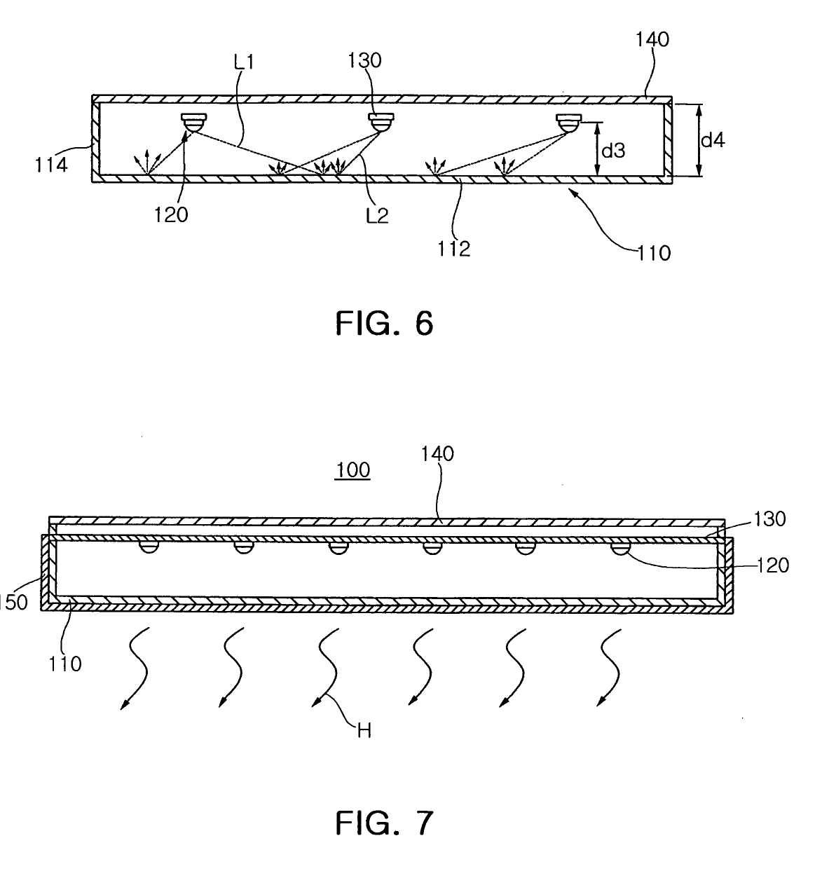

The LEDs 120 are mounted on the underside of the PCBs 130 spaced from the reflective sheet 112 at a distance d1 to emit light toward the reflective sheet 112. The PCBs 130 are a metal PCB made by treating a special coat on a metal plate and then forming a circuit on the coat. The PCBs 130 serve to support the LEDs 120, provide electric power to the LEDs 120, and transfer heat from the LEDs 120 to a heat sink (c.f., FIG. 7) outside the housing 110. That is, the PCBs 130 are connected and supported by both ends to the top of the side walls 114 of the housing 110, and arranged to maintain a predetermined distance d2 from the upper diffuser plate 140.

FIG. 6 is a front cross-sectional view illustrating the operation of the backlight apparatus 100 shown in FIG. 3. As shown in FIG. 6, the LEDs 120 placed in an upper part of the housing 110 emit light directly toward the reflective sheet 112. Light beams reflecting from the reflective sheet 112 reach the diffuser plate 140 placed above the LEDs 120, in which the shortest light path equals d₃+d₄, wherein d₃ is the distance from the focal point of an LED 120 as a light source and the reflective sheet 112, and d₄ is the distance between the reflective sheet 112 and the diffuser plate 140. Besides, for example, when a light beam L1 emitted from an LED 120 advances up to a point of the reflective sheet 112 directly under an adjacent LED 120 and then reflects from the reflective sheet 112, the light beam L1 mixes with a light beam L2 which is emitted from the adjacent LED 120 and then reflects from the reflective sheet 112. In this way, this arrangement can ensure a space for allowing all light beams emitted from the LEDs 120 undergo color-mixing before entering the diffuser plate 140. Accordingly, this arrangement can reduce the thickness of the housing 110 necessary for the color-mixing of monochromatic light beams emitted from the LEDs 120 of different color.

FIG. 7 is a cross-sectional view illustrating the backlight apparatus 100 shown in FIG. 4, mounted with a heat sink 150. As shown in FIG. 7, the heat sink 150 is connected with the PCBs 130 and extended around the housing 110 of the backlight apparatus 100, opposite to the diffuser plate 140. Thus, heat generated from the LEDs 120 are transferred through the metal plates of the PCBs 130 to the heat sink 150, where heat is radiated to the outside or the ambient air as designated with the reference sign H.

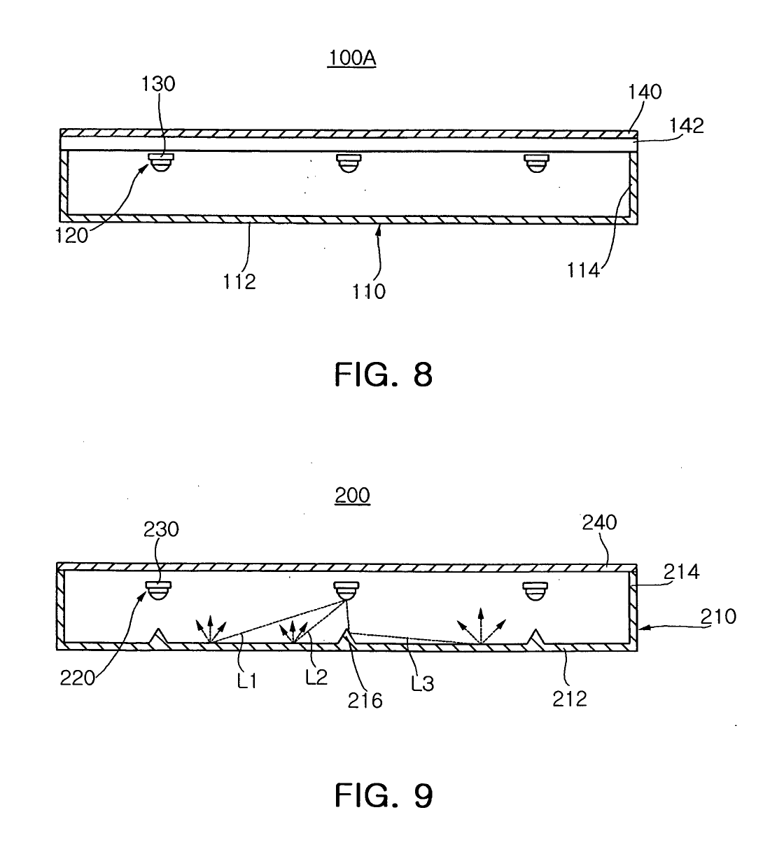

FIG. 8 is a front cross-sectional view of a backlight apparatus 100A as an alternative to the backlight apparatus 100 shown in FIG. 3. The backlight apparatus 100A is substantially the same as the backlight apparatus 100 except that this backlight apparatus 100A has a transparent plate 142 seated on the top of a housing 110 and a diffuser plate 140 mounted thereon. The transparent plate 142 serves to further mix light beams introduced from below and reduce brightness difference, thereby enhancing the performance of the diffuser plate 140.

FIG. 9 is a front cross-sectional view of an LED backlight apparatus 200 according to a second embodiment of the invention. Referring to FIG. 9, the backlight apparatus 200 according to the second embodiment of the invention includes a housing 210 having an upper opening, a plurality of LEDs 220 placed within the housing 210 adjacent to the opening and bar-shaped PCBs 230 connected to side walls 214 of the housing 210 and functioning as a bracket to support the LEDs 220. Besides, a diffuser plate 240 is placed over the opening of the housing 210.

The housing 110 is hollow to receive the LEDs 220 and the PCBs 230, and has a reflective sheet 212 placed in the bottom. The side walls 214 are preferably made of a reflective sheet. The reflective sheet 212 may be preferably made of a Lambertian sheet or have a Lambertian surface formed in its upper surface. Alternatively, a reflective pattern such as ink dots may be selectively or partially provided.

The reflective sheet 212 has projections 216 projected upward from some areas of the reflective sheet 212 opposed to the LEDs 220. The projections 216 function to laterally or horizontally guide light beams L3 emitted directly downward from the LEDs 220. This can ensure that some of the light beams emitted from the LEDs 220 are not retro-reflected to the LEDs 220. As a result, this arrangement can mix light more uniformly inside the housing 210 while preventing light loss.

Other components of the backlight apparatus 200 of the second embodiment are substantially the same as of the backlight apparatus 100 of the first embodiment. Thus, similar components are designated with reference numbers in 200s and their explanation will be represented by that of the first embodiment.

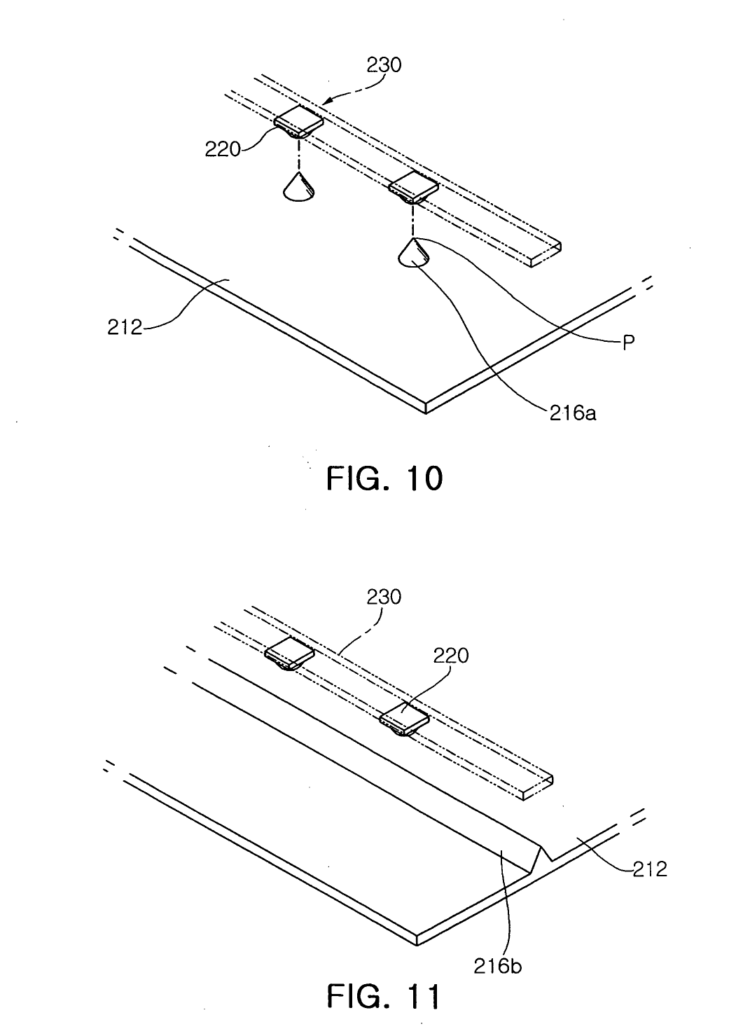

FIGS. 10 to 12 are perspective views illustrating projections adopted to the backlight apparatus shown in FIG. 9.

First referring to FIG. 10, conical projections 216a are formed on a reflective sheet 212 in positions opposed to upper LEDs 220, spaced from one another. Preferably, the focal point of a corresponding LED 220 is on a normal line P of the reflecting sheet 212 passing through the summit of a projection 216a.

FIG. 11 illustrates a prism-shaped projection 216b. The prism-shaped projection 216b is extended on the reflective sheet 212 along a group of LEDs 220. Preferably, the focal points of the LEDs 220 are on a normal plane of the reflective sheet 212 passing through a top edge of the projection 216b.

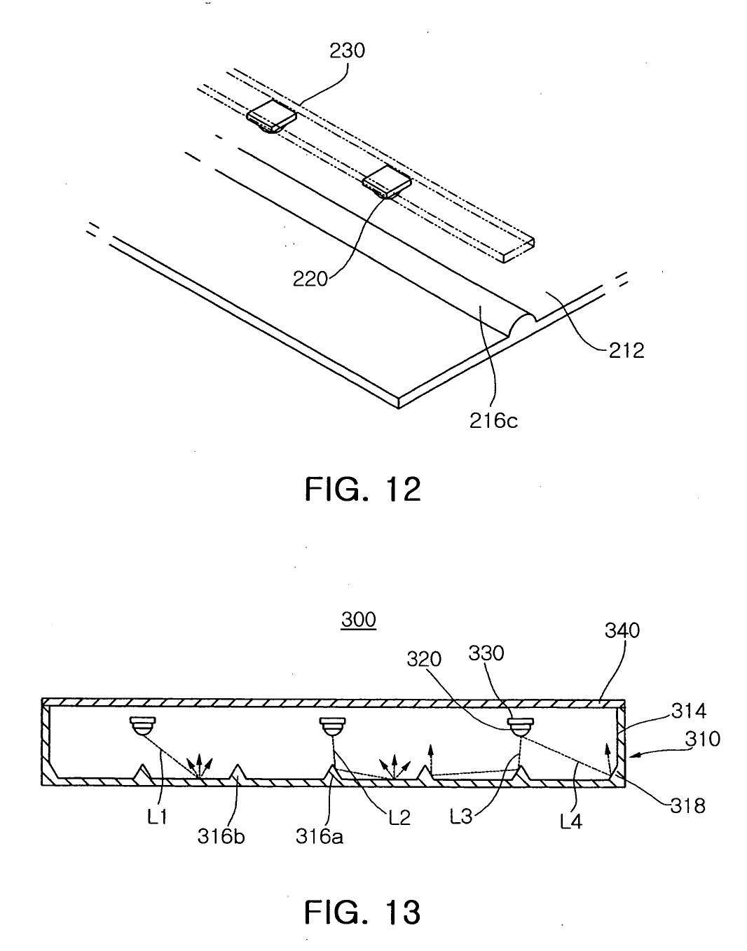

FIG. 12 illustrates a semi-circular projection 216c. The semi-circular projection 216c is extended on the reflective sheet 212 along a group of LEDs 220 mounted on the circuit board 230. Preferably, the focal points of the LEDs 220 are on a normal plane of the reflective sheet 212 passing through an uppermost line of the projection 216c.

FIG. 13 is a front cross-sectional view of an LED backlight apparatus 300 according to a third embodiment of the invention. The backlight apparatus 300 is substantially the same as the backlight apparatus 200 of the second embodiment shown in FIG. 9 except that the backlight apparatus 300 has first projections 316a on a reflective sheet 312 opposed to LEDs 320, respectively, second projections 316b intermediating between the first projections 316a and slopes 316 formed at bottoms of housing side walls 314. The slopes 316 are inclined at the same angle as the projections 316a and 316b. Thus, similar components are designated with reference numbers in 300s, and their explanation will be represented by that of the second embodiment.

According to this backlight apparatus, light beams emitted from a group of LEDs 320 mounted on a single PCB 330 are mainly reflected between the first and second projections 316a and 316b before being guided to a differ plated 340 above the LEDs 320. This as a result can enhance brightness since light beams emitted from the LED 320 group are uniformly mixed in corresponding areas without spreading too wide. In this case, the LED 320 group includes a number of RGB LEDs so that monochromatic ligh beams emitted from the respective LEDs are uniformly mixed forming white light.

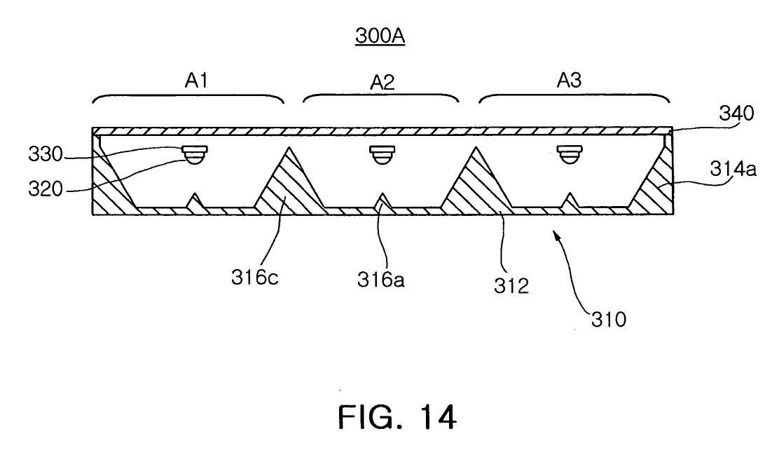

FIG. 14 is a front cross-sectional view of an LED backlight apparatus 300A according to a fourth embodiment of the invention. The backlight apparatus 300A of this embodiment is substantially the same as the afore-described backlight apparatus 300 of the third embodiment except for the following features: Second projections 316c alternating with first projections 316a are projected up to a height adjacent to a diffuser plate 340. Slopes 314a are formed at side walls of the housing 310, and have a height and an slope substantially the same as those of the second projections 316c. Thus, similar components are designated with the same reference signs and their explanation will be represented by that of the thirde embodiment.

With this structure, when emitted from groups of LEDs 320, light beams are reflected from a reflective sheet 312, the first and second projections 316a and 316c and the slopes 314a, and introduced into corresponding areas A1, A2 and A3 of the diffuser plate. That is, light beams emitted from a group of LEDs 320 arranged under one diffuser plate area A1 are all or almost introduced exclusively into the diffuser plate area A1.

While the second projections 316c are projected to the height adjacent to the diffuser plate 340, the invention is not limited thereby. The second projections 316c may be extended upward to an extent that light beams emitted from a group of the LEDs 320 can be introduced into a corresponding one of the diffuser plate areas A1, A2 and A3 without entering another diffuser plate area. For example, the second projections 316c may be extended upward to an extent of passing beyond the LEDs 320, and more particularly, beyond focal points of the LEDs 320.

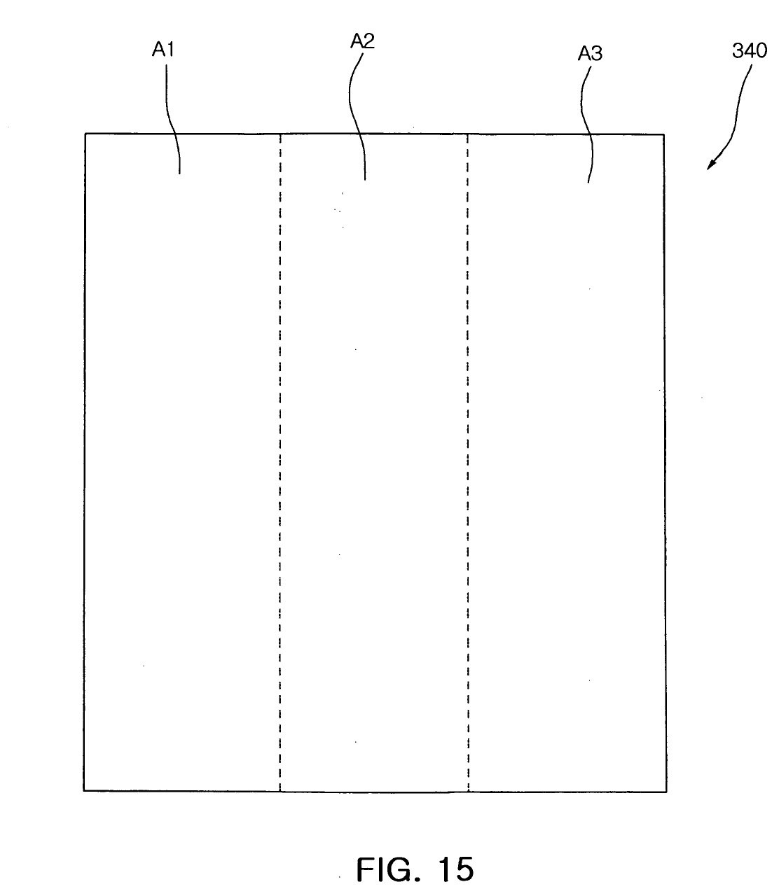

In the backlight apparatus 300A of this structure, the diffuser plate 340 can be divided into the three areas A1, A2 and A3 as shown in FIG. 15. The backlight apparatus 300A of this structure has following advantages. When the LEDs 320 of the backlight apparatus 300A are selectively turned on/off according to corresponding PCBs 330 or the areas A1, A2 and A3, for example, so that LEDs 320 in the area A1 are turned on but LEDs 320 in the area A2 are turned off, light beams emitted from the LEDs 320 in the area A1 will not enter the area A2 at all or rarely. By turning the LEDs 320 of the backlight apparatus 300A on/off according to the PCBs 330 or the areas A1, A2 and A3 (e.g., at a frequency of 60 Hz or more), it is possible to prevent afterimages in an LCD panel.

According to the present invention as described hereinbefore, the LED light sources are arranged opposite to the reflective sheet so that light beams emitted from the LED light sources are reflected from the reflective sheet and then introduced into the diffuser plate placed behind the LED light sources, thereby to reduce the thickness of the backlight apparatus while ensuring a space sufficient for the light beams to mix together before entering the diffuser plate.

Besides, the projections are formed on the reflective sheet opposed to LED light sources to mix light beams emitted from the LED light sources more uniformly while preventing any loss of the light beams.

In addition, the intermediate projections are formed on the reflective sheet corresponding to areas each intermediating between adjacent LED light sources so that light beams emitted from the LED light sources are reflected upward mostly from areas between adjacent intermediate projections, thereby to prevent wide spreading of light and thus to enhance brightness.

Furthermore, the intermediate projections are extended up to a height adjacent to a diffuser plate so that light beams emitted from a group of LEDs between adjacent intermediate projections are introduced exclusively into a corresponding area of the diffuser plate, thereby to further enhance brightness.

While the present invention has been shown and described in connection with the preferred embodiments, it will be apparent to those skilled in the art that modifications and variations can be made without departing from the spirit and scope of the invention as defined by the appended claims.

What is claimed is:

1. An LED backlight apparatus comprising:
a housing having an upper opening;
a reflective sheet provided on a bottom inside the housing;
a plurality of LED light sources arranged above the reflective sheet at a predetermined distance to emit light toward the reflective sheet; and
a light source support connected to a side wall of the housing to support the LED light sources.

2. The LED backlight apparatus according to claim 1, further comprising a projection extended upward from the reflective sheet at positions corresponding to the LED light sources.

3. The LED backlight apparatus according to claim 2, further comprising a second projection alternating with the projection.

4. The LED backlight apparatus according to claim 3, wherein the projection and the second projection have a triangular vertical cross section.

5. The LED backlight apparatus according to claim 3, wherein the projection and the second projection have a semicircular cross section that is convex-upward.

6. The LED backlight apparatus according to claim 5, wherein the second projection is extended to the same level as that of the LED light sources.

7. The LED backlight apparatus according to claim 1, further comprising a diffuser plate placed over the opening of the housing.

8. The LED backlight apparatus according to claim 7, further comprising a transparent plate placed between the housing and the diffuser plate.

9. The LED backlight apparatus according to claim 1, wherein the support comprises a bar-shaped metal PCB with the LED light sources attached to a bottom thereof.

10. The LED backlight apparatus according to claim 1, further comprising a heat radiator provided on an outer surface of the hosing, the heat radiator being connected to the metal PCB.

11. The LED backlight apparatus according to claim 1, wherein the reflective sheet comprises a Lambertian surface.

12. An LED backlight apparatus comprising:
a housing having an upper opening;
a reflective sheet provided on a bottom inside the housing;
a plurality of LED light sources arranged above the reflective sheet at a predetermined distance to emit light toward the reflective sheet;
a plurality of first projections extended upward from the reflective sheet at positions corresponding to the LED light sources, respectively;
a plurality of second projections extended upward from the reflective sheet, alternating with the first projections; and
a light source support connected to a side wall of the housing to support the LED light sources.

13. The LED backlight apparatus according to claim 12, wherein the first and second projections have a triangular vertical cross section.

14. The LED backlight apparatus according to claim 12, wherein the first and second projections have a semicircular cross section that is convex-upward.

15. The LED backlight apparatus according to claim 12, wherein the second projections are extended to the same level as that of the LED light sources.

16. The LED backlight apparatus according to claim 12, further comprising a diffuser plate placed over the opening of the housing.

17. The LED backlight apparatus according to claim 16, further comprising a transparent plate placed between the housing and the diffuser plate.

18. The LED backlight apparatus according to claim 12, wherein the support comprises a bar-shaped metal PCB with the LED light sources attached to a bottom thereof.

19. The LED backlight apparatus according to claim 12, further comprising a heat radiator provided on an outer surface of the hosing, the heat radiator being connected to the metal PCB.

20. The LED backlight apparatus according to claim 12, wherein the reflective sheet comprises a Lambertian surface.
